(19) United States
(12) Patent Application Publication
(10) Pub. No.: US 2022/0070365 A1
(43) Pub. Date: Mar. 3, 2022

(54) MIXED REALITY IMAGE CAPTURE AND SMART INSPECTION

(71) Applicant: Microsoft Technology Licensing, LLC, Redmond, WA (US)

(72) Inventors: Maya A. MILLER-VEDAM, Vancouver (CA); Colin GARVEN, Vancouver (CA); Kjartan OLAFSSON, Vancouver (CA); Kevin Thomas MATHER, Mountain View, CA (US)

(21) Appl. No.: 17/107,151

(22) Filed: Nov. 30, 2020

Related U.S. Application Data
(60) Provisional application No. 63/071,784, filed on Aug. 28, 2020.

(51) Int. Cl. H04N 5/232; G06T 7/70; G06T 11/00; G06T 3/20; G06T 3/40

(52) U.S. Cl. CPC H04N 5/23222; H04N 5/232945; G06T 7/70; G06T 2200/24; G06T 3/20; G06T 3/40; G06T 2207/20081; G06T 11/00

(57) ABSTRACT

A mixed reality image capture system performs actions to guide a user toward a predefined vantage point to ensure image capture from a consistent vantage point. The system includes a mixed reality frame alignment tool that controls projection optics to project a first virtual target and a second virtual target within a camera field-of view. The first virtual target is projected at a first location within the camera field-of-view that is fixed relative to an identified real-world anchor object and the second virtual target is projected at a second location within the camera field-of-view that is fixed relative to a position of the camera. As the user moves the camera relative to the real-world anchor object, the mixed reality frame alignment tool dynamically updates a position of the second virtual target to mirror movements of the camera. The system further includes an image capture tool that captures a photo of a real-world subject when the first location and the second location satisfy a predefined spatial relationship.

### CROSS-REFERENCE TO RELATED APPLICATIONS

The present application claims priority to U.S. provisional application No. 63/071,784, entitled “Mixed Reality Image Capture and Smart Inspection,” and filed on Aug. 28, 2020, which is hereby incorporated by reference for all that it discloses or teaches.

### BACKGROUND

Some businesses endeavor to keep and maintain photographic documentation, such as photographs documenting project stages or product quality or consistency (e.g., coherence to a given standard). For example, assembly line operators may be tasked with taking photographs of products at various stages of assembly and/or be tasked with inspecting products for defects and characteristics of interest. When photographing multiple instances of a same product, a human operator may take photographs of each individual product from a slightly different vantage points. Moreover, certain product details—such as defects—may be more or less visible from different vantage points. Since human-captured photos may lack consistency in perspective, it can be difficult to use such photos as a basis for subsequently comparing or assessing the imaged products. Furthermore, human operators often make mistakes and/or apply inconsistent standards when inspecting products.

### BRIEF DESCRIPTIONS OF THE DRAWINGS

FIG. 1 illustrates an example processing device that provides a mixed reality user experience for collecting and inspecting real-world images.

FIG. 2 illustrates an example of how a mixed reality frame alignment tool may dynamically update the position of a digital target when guiding a user to position a camera at a predefined vantage point.

FIG. 3A illustrates example digital targets generated by a mixed reality frame alignment tool.

FIG. 3B illustrates a relative shift in positions of the digital targets shown in FIG. 3A that occur when a user moves a camera toward a predefined vantage point.

FIG. 3C illustrates another relative shift in the positions of the digital targets shown in FIG. 3B that occur when a user moves the camera to a position consistent with the predefined vantage point.

FIG. 3D illustrates exemplary menu options of an image inspection tool that may be presented following the capture of the photo as described above with respect to FIG. 3A-3C

FIG. 4 illustrates example operations for guiding a user to position a camera at a predefined vantage point relative to an image subject.

FIG. 5 illustrates an example schematic of a processing device suitable for implementing aspects of the disclosed technology.

### SUMMARY

An exemplary system includes a mixed reality frame alignment tool that controls projection optics to project a first virtual target and a second virtual target within a camera field-of view. The first virtual target is projected at a first location within the camera field-of-view that is fixed relative to an identified real-world anchor object, and the second virtual target is projected at a second location within the camera field-of-view that is fixed relative to a position of the camera. As the user moves the camera relative to the real-world anchor object, the mixed reality frame alignment tool dynamically updates a position of the second virtual target to mirror movements of the camera. The system further includes an image capture tool that captures a photo of a real-world subject when the first location and the second location satisfy a predefined spatial relationship.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other implementations are also described and recited herein.

### DETAILED DESCRIPTIONS

The herein disclosed technologies include image capture and image inspection features that may be of particular use in systems relying on the capture and/or maintenance of photograph records, such as product inspection systems for quality assurance, procedural inspections or documentation (e.g., photographic documentation of phases of construction or medical procedures). According to one implementation, a system disclosed herein includes a mixed reality frame alignment tool that guides a user to a predefined vantage point to position a camera to capture a photo of a subject. The capture of the photo from the predefined vantage point may, for example, serve to ensure that certain features of the subject are visible and/or that a collection of images of the same subject (or different copies of a subject, e.g., an assembly line product) are photographed from a substantially similar or identical vantage point to produce a consistent image set. As used herein, two vantage points are “substantially similar” when the positional deviation between the two vantage points is less than or equal to approximately 10% along any individual axis. Two or more vantage points that are substantially similar are collectively referred to as a single “consistent” vantage point.

According to another implementation, aspects of the disclosed system provide a platform that allows a human operator to train a machine learning model on a set of images of a subject collected from a consistent vantage point. For example, the operator may provide inputs in association with each photo indicating whether the subject in each photo is consistent or inconsistent with a particular standard. Once trained, the machine learning model may dynamically evaluate new images of the subject (e.g., from a production line) and objectively determine whether subjects in the new images are consistent or inconsistent with the standard. In some implementations, outputs of the machine learning model are subjected to further processing and analysis, and the system is adapted to provide real-time feedback, such as to inform an operator when a product has a defect or to summarize an analysis of a particular product imaged. For example, an operator on a manufacturing assembly line may take a photo of a product component and receive immediate real-time feedback indicating whether the product meets a defined quality standard.

In still further implementations, the disclosed technology provides for “touchless” image capture, allowing an operator to capture an image of a subject without providing input (e.g., verbal or tactile input) instructing the system when to capture the photo. For example, a photo may be automatically captured when the system detects that a vantage point of the camera field-of-view satisfies predefined criteria relative to one or more recognized objects in a scene.

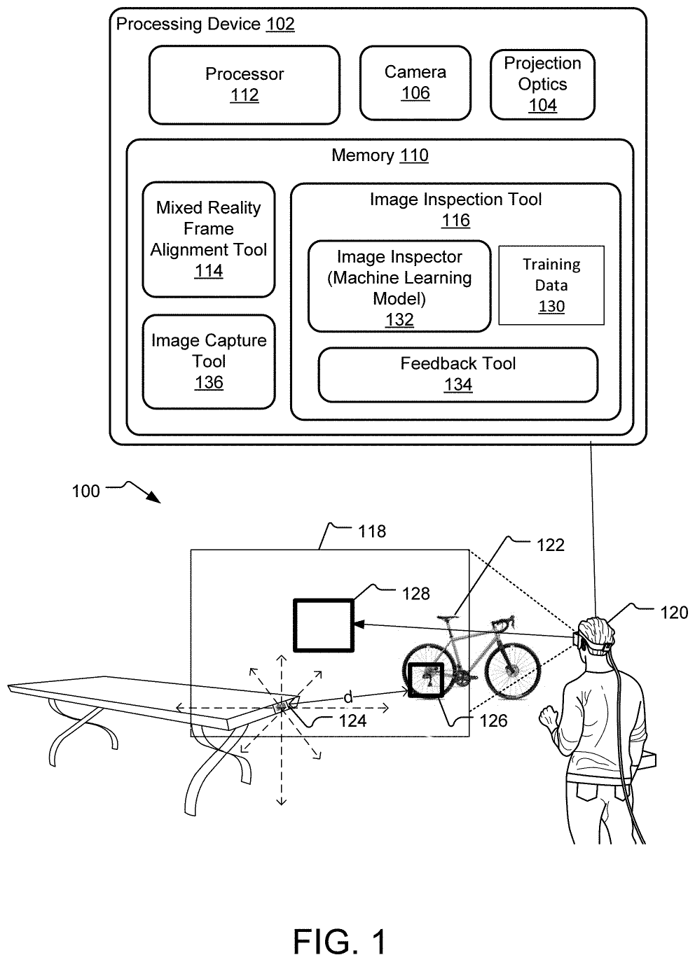

FIG. 1 illustrates an example processing device 102 that provides a mixed reality user experience for collecting and inspecting real-world images. By example and without limitation, the processing device 102 is shown to be a head-mounted-device (HMD) capable of projecting digital objects within a three dimensional (3D) real-world frame of reference such that the digital objects and real objects coexist in the user's line of sight. Although HMDs are the primary example device contemplated herein, the disclosed technology may be suitable for implementation in any mixed reality device including, for example, devices that provide 2D mixed reality experiences.

The processing device 102 includes projection optics 104 for projecting detail objects within a field-of-view 118 of a user 120 wearing or interacting with the processing device 102, and also includes a camera 106 usable to capture still images or video frames of the real-world environment surrounding the user 120 and/or of the mixed reality experience that is presented to the user 120. Although the projection optics 104 and the camera 106 may, in some devices, be separately located on the processing device 102 (e.g., with different or slightly different fields-of-view), the examples in the present disclosure assume that the camera 106 is capable of capturing images within the field-of-view 118 of the HMD that is worn by the user 120.

The processing device 102 further includes memory 110 storing an operating system (not shown) and one or more applications executable by the processor 112. Among other applications, the processing device 102 stores and locally executes a mixed reality frame alignment tool 114 and an image inspection tool 116. In some implementations, aspects of the mixed reality frame alignment tool 114 and/or the image inspection tool 116 may be remotely executed by a device in communication with processing device 102 over a local or wide area network. Some implementations of the disclosed technology may implement either the mixed reality frame alignment tool 114 or the image inspection tool 116, but not both.

The mixed reality frame alignment tool 114 is an application that guides a user to position the processing device 102—and more specifically, a lens of the camera 106—at a particular predefined vantage point relative to a subject of interest. Once the mixed reality frame alignment tool 114 determines that the lens of the camera 106 is positioned at the predefined vantage point, the mixed reality frame alignment tool 114 transmits an instruction to the image capture tool 136, such as an instruction to automatically capture a photo with the camera 106 or an instruction to prompt a user to provide input to trigger the photo capture. The captured photo may then optionally be provided to an image inspection tool 116, which is discussed in further detail below.

Although there exist a variety of exemplary use cases for this technology, the disclosed example pertains to product inspection. When an operation at a manufacturing facility finishes a particular stage of work on a photographic subject of interest 122 (e.g., a component on a bicycle), the operator may be tasked with capturing a photo of the photographic subject of interest 122 such that the general condition, quality, and other characteristics of the product are documented and available for subsequent assessment by another party, such as a human or machine inspector.

In one implementation, the mixed reality frame alignment tool 114 helps the user 120 collect multiple photos of a scene 100 (or a particular location within the scene) from a consistent vantage point (e.g., a consistent direction, depth, and/or 3D angular separation) relative to the photographic subject of interest 122 that is within the scene and captured within each photo. For example, the multiple photos may be of a same product, different copies of a product (e.g., a production line that outputs many copies of a product) or different products that are, at different times, positioned substantially similarly within the scene 100.

When the mixed reality frame alignment tool 114 is executing, a user initiates an image capture mode by pointing the camera 106 at a predefined real-world anchor object (e.g., anchor object 124), such as by positioning the HMD with the anchor object 124 in the field-of-view 118 of the HMD or near the center of the field-of-view 118. By example and without limitation, the anchor object 124 of FIG. 1 is a bar code sticker that has been placed at a location (e.g., on a table) that has a known, predefined spatial separation relative to a subject of interest within the scene 100 (e.g., a rear derailleur on the bicycle). The anchor object 124 may, for example, be defined by a system administrator during a set-up phase of the mixed reality frame alignment tool 114, such as by uploading a photo of the anchor object or providing other instruction usable by the system to readily identify the anchor object 124 in the scene 100.

In different implementations, the anchor object may assume a variety of forms such as that of a bar code, QR code, or any other object that is easily identified by a computer program. Notably, the use of a bar code or QR code as the anchor object 124 may allow the system to pull a product identifier from a database to associate with the photo that is to be captured, which may be useful for documentation, indexing, etc. In some implementations, the subject of interest being photographed (e.g., bicycle derailleur) may itself serve as the anchor object 124.

When the mixed reality frame alignment tool 114 recognizes the anchor object 124 in the field-of-view 118, the mixed reality frame alignment tool 114 defines a 3D coordinate system with an origin corresponding to a position of the anchor object 124 and projects a first digital target 126 (e.g., a holographic target) at a predetermined location that is defined by an offset vector ‘d’ relative to the anchor object 124. Throughout the duration of the image capture process, this first digital target 126 remains fixed at this position. Thus, even as a user moves the processing device 102 to alter the view of the view 118 of the camera 106, such as by moving his/her head from left to right, the first digital target 126 remains anchored relative to real-world objects in the scene (e.g., appearing fixed relative to the rear derailleur of the bicycle).

In some implementations, the offset vector ‘d’ is defined, during a set-up phase of the application, with respect to a known position of the anchor object 124 and the known anticipated of the product 122 or other subject that is to be photographed. For example, a system administrator may define the offset vector ‘d’ when initializing system parameters for the image inspection tool 112.

This offset vector ‘d’ represents the location relative to the anchor object 124 at which the first digital target 126 is to be projected each time the mixed reality frame alignment tool 114 is executed. Ideally, the offset vector ‘d’ is defined so as to project the first digital target 126 onto an anticipated position of a subject of interest. For example, it may be assumed that the photographic subject of interest 122 is to be photographed when placed on a stage of known distance relative to the anchor object 124. In the illustrated example where the user 120 is documenting the appearance of the rear derailleur on the bicycle, the user 120 may, for example, position the bicycle with the front and rear tires in alignment with predefined positions, markings, etc. so as to ensure that the rear derailleur is offset from the anchor object 124 by the distance and orientation defined by the offset vector ‘d.’ In another implementation, the mixed reality frame alignment tool 114 self-defines the offset vector ‘d’, such as based on one or more input images that depict both a predefined anchor object 124 and a predefined photographic subject of interest 122.

Although the anchor object 124 is, in the illustrated example, shown to be spatially separated from the subject that is to be photographed (e.g., the product 122), it is to be understood that the anchor object 124 may, in some cases, be the subject that is to be photographed or, alternatively, be a component located on the subject that is to be photographed. For example, the image inspection tool 116 may employ image-recognition technology to identify the photographic subject of interest 122 and automatically project the first digital target 126 at the recognized position of the photographic subject of interest 122.

In another implementation, the anchor object 124 is a QR sticker or other object located on the subject of photographic interest (e.g., the rear derailleur of the bicycle). In either of the above cases, the system administrator may define the offset vector ‘d’ to be zero to indicate that the first digital target 126 is presented to coincide with a region of the scene 100 that includes the anchor object 124.

In addition to projecting the first digital target 126, the mixed reality frame alignment tool 114 also controls the projection optics 104 to project a second digital target 128 (e.g., another holographic target) within the line-of-sight of the user 120. The second digital target 128 is projected at a location that is fixed relative to the camera 106 and dynamically movable relative to the scene 100 throughout the duration of the photo capturing process. For example, the second digital target 128 is projected to appear at a point in space at a fixed offset [x, y, x] relative to the location of the camera 106 in the coordinate system defined by the anchor object 124, even as the camera 106 is physically moved in space. Consequently, the position of the second digital target 128 is dynamically updated in time to move throughout the field-of-view 118 as the user 120 moves the camera 106 and changes the field-of-view 118 (e.g., by moving his/her head from left-to-right, up, down, etc.) For example, the second digital target 128 may always appear fixed at location corresponding to a center of the field-of-view 118. In order to capture a photo of the subject (e.g., the rear derailleur on the bicycle), the user physically moves the camera 106 in space to bring the second digital target 128 into alignment with the first digital target 126, which remains fixed relative to the anchor object 124. In the illustrated example, this may entail the user 120 looking down slightly and to the right in order to vary the apparent location of the second digital target 128 such that it aligns with the first digital target 126 within the line-of-sight of the camera 106 and the user 120.

As the user moves the camera 106, the mixed reality frame alignment tool 114 may alter the position, size, and orientation of the second digital target 128 based on the changes in the field-of-view of the camera 106. In one implementation, the size of the second digital target 128 varies with changes in distance from the projected location of the first digital target 126. If, for example, the user steps closer to the fixed location of the first digital target 126 (e.g., the position of the photographic subject of interest 122), this may cause the second digital target 128 to shrink; alternatively, stepping away from the same fixed location may cause the second digital target 128 to grow.

In some implementations, the mixed reality frame alignment tool 114 alters the angular separation between the first digital target 126 and the second digital target 128 responsive to detected changes in the angular separation between the lens of the camera 106 and the fixed position of the first digital target 126. For example, the second digital target 128 may initially appear oriented in a first plane perpendicular to the user's line-of sight while the first digital target 126 initially appears to extend within a second plane that is different from and non-parallel to the first plane. As user 120 walks around the photographic subject of interest 122 and approaches the predefined vantage point, the projection plane of the of the first digital target 126 may shift such that the first digital target 126 becomes more parallel to the second digital target 128 with decreasing separation between the user 120 and the predefined vantage point.

When the second digital target 128 satisfies a predefined spatial relation relative to the first digital target 126, a photo of the subject is captured. For example, the user 120 may move the camera 106 in space until the second digital target 128 aligned with the first digital target 126. In the same or another implementation, the user 120 moves the camera 106 to shift the apparent size and/or orientation of the second digital target 128 until the size and/or orientation of second digital target 128 is similar enough to that of the first digital target 126 to satisfy a predefined similarity threshold.

In one implementation, the mixed reality frame alignment tool 114 automatically captures the photo of the subject when the predefined spatial relation is satisfied without requiring input from the user 120. That is, the user does not provide input defining when the photo is to be captured or that directly triggers capture of the photo. Rather, the photo is automatically captured by the image capture tool 136 when the camera is positioned at the predefined vantage point relative to the anchor object 124 and the image subject (at the position defined by offset vector ‘d’ relative to the anchor object 124). In this sense, the photo is captured “touchlessly” and without user input. In still other implementations, the user 120 provides input (e.g., touch or voice) to instruct the image capture tool 126 to capture the photo.

In some implementations, the mixed reality frame alignment tool 114 provides the user 120 with real-time feedback when the predefined spatial relation between the virtual targets is satisfied, such as by providing a visual or audio cue. This may serve to convey to the user 120 that the photo has been automatically captured or, alternatively, to prompt the user to provide input that triggers capture of the photo.

In different implementations, the first digital target 126 and second digital target 128 may assume a variety of forms. In the illustrated implementation, the two virtual targets are rectangular. Here, the image that is captured may include the entire field-of-view 118 or instead correspond to a subset of the field-of-view 118 that is otherwise defined by the position of the first digital target 126. For example, the photo captured may have a field-of-view corresponding precisely to the dimensions of the rectangular target such that the captured image includes the portion of the scene 100 that appears internal to the rectangular target and excludes the portion of the scene 100 that appears external to the rectangular target.

To illustrate one example use of the images captured via the mixed reality frame alignment tool 114, the processing device 102 is shown to further include an image inspector 132. The image inspector 132 is, for example, a trained machine learning model. In one implementation, the image inspector 132 is trained with training data 130 that includes an image set and supervised learning inputs provided by a system administrator. For example, a system administrator may utilize the mixed reality frame alignment tool 114 to collect a set of images of products of a product of a same product type (e.g., identical make/model but different serial numbers) positioned at a same assembly position. The system administer may train the model to recognize a “defective product” by providing these images along with further supervised learning inputs that indicate whether each image illustrates a satisfactory product or a defective product. Since the image set is highly consistent regarding the position of the product within each image, the trained model exhibits a higher degree of reliability than similar models trained using images of a subject taken from less consistent vantage points. Additionally, it has been demonstrated that trained machine learning models are capable of more consistent evaluation than human inspectors. For example, human inspector may not notice a defect and/or different human inspectors may apply different standards when tasked with the same role.

The image inspection tool 116 may, in some implementations, further include a feedback tool 134 that provides real-time feedback to the user 120. If, for example, the user 120 captures an image of the subject using the mixed reality frame alignment tool 114, this image may be provided to the image inspector 132 which, in turn, determines whether the subject in the image has a particular characteristic (e.g., whether the product is defective). The feedback tool 134 conveys, in real time, the output of the image inspector 132 back to the user 120, such as through a user interface of the processing device 102. In this scenario, the user 120 may be informed immediately (e.g., within seconds of capturing a photo) of whether or not the photo satisfies the criteria that has been evaluated by the image inspector 132.

In still other implementations, the image inspection tool 116 does not utilize trained AI to inspect the photo. Rather, the image inspection tool 116 provides the user with further tools for better assessing the photo and features visible in the photo. For example, the image inspection tool 116 may pull one or more reference images from a database and project them alongside of the captured photo for the user 120 to evaluate the differences.

Although the examples described herein generally refer to scenarios where a single image is captured with respect to each photographic subject of interest, some implementations of the mixed reality frame alignment tool may include logic to instruct the user 120 to position the camera at a variety of different predefined vantage points, such as to collect a set of images of the subject corresponding to each one of multiple predefined vantage points. For example, the system administrator may initially provide the system with inputs that define different orientations of the first virtual target 126 corresponding to different vantage points. One by one, the mixed reality frame alignment tool 114 may select each of the different vantage points and employ the above-described features to guide the user to the select vantage point. For example, the mixed reality frame alignment tool 114 may shift the angular orientation of the first digital target 126 relative to the user after each image capture, causing the user to walk around the object (e.g., 90 degrees to the right or left) to again align the angular orientation of the second digital target 128 with the new (shifted) angular orientation of the second digital target 128. This may be repeated to guide the user to each different one of the predefined vantage points.

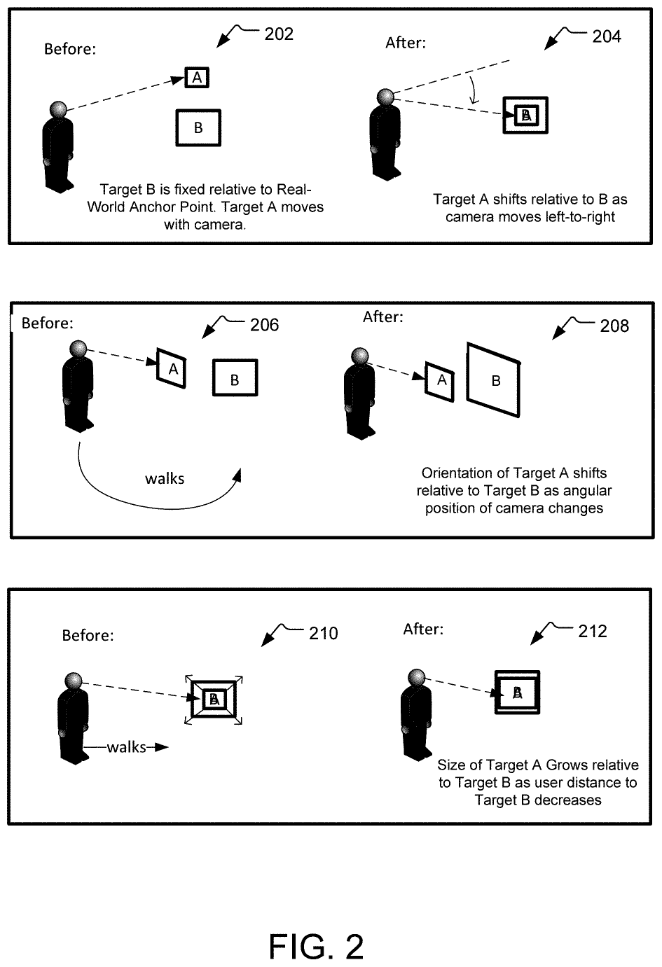

FIG. 2 illustrates an example of how a mixed reality frame alignment tool may dynamically update the position of a digital target when guiding a user to position a camera at a predefined vantage point relative to a subject or position of interest. The examples in FIG. 2 depict a human figure. The following description presumes that the human figure is wearing a mixed-reality head-mounted device (HMD) with the same or similar characteristics to the processing device 102 of FIG. 1. In this example, a line-of-sight of the camera is presumed to be substantially similar or identical to a line-of-sight of the user.

When an image capture mode is entered (at view 202), the mixed reality frame alignment tool projects a first digital target (A) and a second digital target (B). The second digital target (B) is projected at a location that is fixed relative to a recognized “anchor object” in the real-world scene, such as in the manner disclosed with respect to FIG. 1. It is assumed that the projected location of the second digital target corresponds to a real-world location of a subject that the user wants to photograph.

The second digital target (B) remains fixed (e.g., anchored) to a stationary position within the real-world scene throughout the image capture process while the first digital target (A) is moved by a projection system of the HMD to mirror movements of a system camera. Thus, the user observes movements of the first digital target (A) relative to the scene and also relative to the second digital target (B).

When the user looks upward as shown in view 202, the camera's line of sight is also upward is angled (at a position indicated by a dotted arrow) such that camera's line-of-sight intersects a position directly above the second digital target (B). This signifies that the user's directional orientation relative to the image subject differs from that of the predefined vantage point. As the user lowers his/her gaze to move the HMD downward, the first digital target (A) shifts in position (from the user perspective) to align with the second digital target (B), as shown in view 204. In this example, the user has re-oriented the camera to have a directional alignment relative to a target that is consistent with a predefined vantage point.

As illustrated in another view 206, the first digital target (A) may initially appear in a plane that is non-parallel to a plane of the second digital target (B). This signifies that the user's angular orientation relative to the image subject differs from that of the predefined vantage point. As the user walks in a circle around the image subject (e.g., around the fixed real-world position of the second digital target (B), the angular orientation of the second digital target (B) appears to shift while the angular orientation of the first digital target (A) is fixed parallel to the user's line-of-sight. The two planes appear parallel to one another, as shown in view 208, when the camera is angled in a manner that coincides with angle associated with the predefined vantage point. In this example, the user has re-oriented the camera to have an angular orientation relative to a target that is consistent with a predefined vantage point.

As illustrated in yet another view 210, the first digital target (A) and the second digital target (B) may have different sizes even when they appear aligned in direction and planar orientation within the user's line-of-sight. This signifies that the user's separation from the image subject differs from that of the predefined vantage point. In this example, the first digital target (A) grows larger in size when the user walks toward the fixed real-world position of the second digital target (B) and smaller in size when the user walks in the opposite direction, as shown in view 212. Notably, other visual effects may be used to convey the same concept. When the user reaches a distance from the image subject that corresponds to a depth of the predefined vantage point, the first digital target (A) and the second digital target (B) are approximately the same size indicating that the user has re-oriented the camera to have a depth relative to a target that is consistent with a predefined vantage point.

As described above with respect to FIG. 1, a mixed reality frame alignment tool may capture a photo of a target responsive to determining that the first digital target (A) and the second digital target (B) satisfy a predefined spatial relationship. In different implementations, the predefined spatial relationship may be satisfied based on different criteria—such as based on one or more conditions defined with respect to directional alignment, angular orientation, and/or depth. Some implementations may impose more stringent conditions (e.g., such as to ensure consistency with respect to the directional alignment, angular orientation, and depth associated with a predefined vantage point) while others may impose less stringent conditions (e.g., such as to ensure consistency with respect to fewer than all three of the directional alignment, angular orientation, and depth associated with the predefined vantage point).

In the example of FIG. 2, satisfaction of the predefined spatial relationship depends upon directional orientation of the camera relative to the image target, angular separation of the camera relative to the image target, and depth of the camera relative to the image target. A directional orientation condition is satisfied at 204; the angular separation condition is satisfied at 208, and a depth condition is satisfied at 212. When, at 212, the user reaches a location relative to the image subject that is consistent with a depth of the predefined vantage point, the first digital target (A) and the second digital target (B) are aligned in position (e.g., along the user's line of sight) as well as in size and in angular orientation relative to one another. The mixed reality frame alignment tool 114 determines that the predefined spatial relationship is satisfied between the targets and either captures an image automatically or conveys output to the user to signify that the camera is at the predefined vantage point such that the user can manually take a photo, such as by providing touch, voice, or visual input to the system.

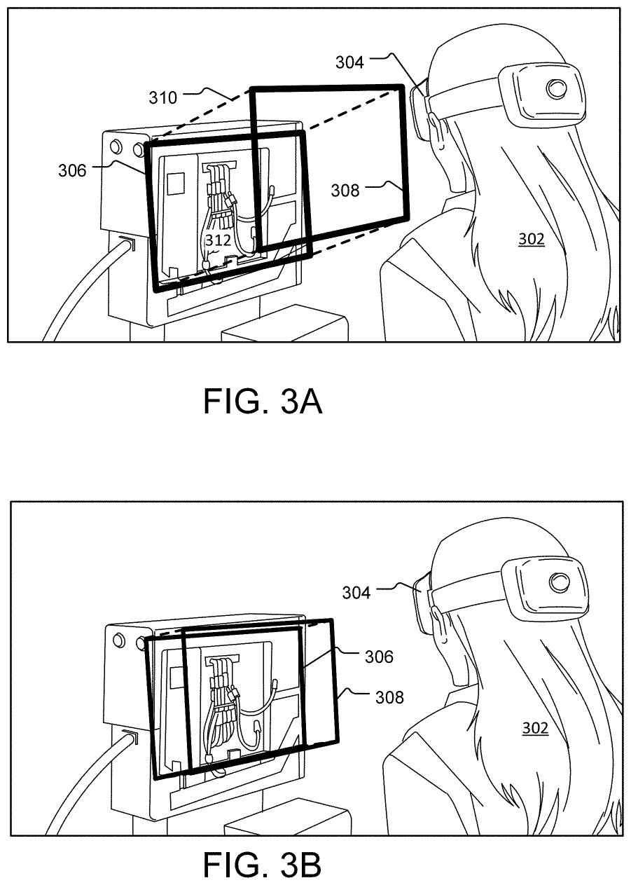

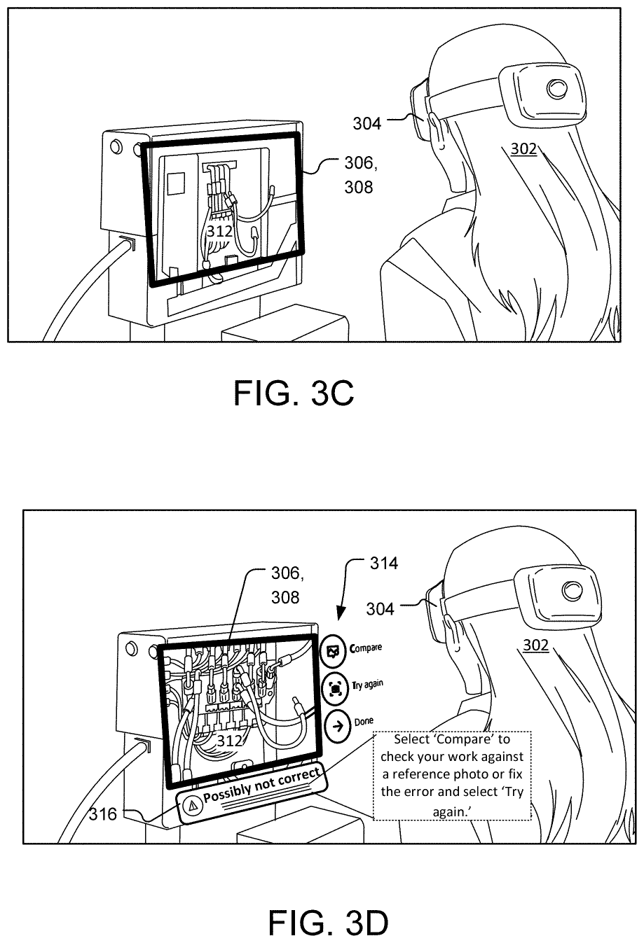

FIGS. 3A-3D illustrate example projections of a mixed reality frame alignment tool operable to guide a user to position a camera at a pre-defined vantage relative to a subject 312 of photographic interest. FIG. 3A illustrates initial positions of example digital targets generated by a mixed reality frame alignment tool executing on an HMD 304. Here, a user 302 is shown wearing the HMD 304. The mixed reality frame alignment tool controls projection optics of the HMD 304 to project a first digital target 306 at a fixed position relative to stationary objects visible through the optics of the HMD 304. For example, the mixed reality frame alignment tool may define a coordinate system that has an origin fixed on a recognized anchor object within the scene. The first digital target 306 is projected at a predefined offset relative to the recognized anchor object (e.g., as described with respect to FIG. 1), at a position corresponding to a subject of photographic interest. The mixed relative frame alignment tool also controls the projection optics to project a second digital target 308 at a position that is fixed relative to the HMD 304. Thus, as the user 302 moves her head to alter the position of the HMD 304, the second digital target 308 moves to mirror this position. When the HMD 304 is moved to a predefined vantage point relative to the subject 312, the first digital target 306 and the second digital target 308 have relative positions that satisfy a predefined spatial relationship. As described above with respect to FIG. 1-2, satisfaction of the predefined spatial relationship may, depending up on the implementation, cause the HMD 304 to automatically capture a photo of the subject of photographic interest or, alternatively, prompt a user for an input that triggers the image capture.

In the example of FIGS. 3A-3D, the mixed reality frame alignment tool projects guide rails 310 that provide directional cues to the user 302. For example, the downward slant of the guide rails 310 in FIG. 3A informs the user 302 to move her gaze downward. In some implementation, the guide rails may be animated to indicate the directional movements of the user 302 that are requisite to guide the HMD 304 to a predefined vantage point relative to the subject of photographic interest. For example, the guide rails may include dotted lines that appear to move from the second digital target 208 toward the first digital target 306. In other implementations, other animated features may be projected to guide the user to position the HMD 304 at the predefined vantage point.

FIG. 3B illustrates a relative shift in the positions of the digital targets 306, 308 that occurs when a user moves a camera toward a predefined vantage point from the position illustrated in FIG. 3A. Specifically, FIG. 3B illustrates a downward shift in the position of the second digital target 308 that occurs when the user 302 moves her head to angle her gaze downward toward the first digital target 306 to better align the first digital target 306 with the second digital target 308.

FIG. 3C illustrates another relative shift in the positions of the digital targets 306, 308 that occur when a user moves the HMD 304 to a position consistent with the predefined vantage point. Here, the user 302 has moved her head from the position shown in FIG. 3B to angle her gaze still further downward toward the first digital target 306 such that the second digital target 308 moves into relative alignment with the first digital target 306. In one implementation, the mixed reality frame alignment tool provides the user 302 with a visual or audio cue to indicate that the HMD 304 is now at a position consistent with that of the predefined vantage point. For example, the first digital target 306 and the second digital target 308 may merge into a single target and/or the color of the targets may change. In one implementation, an audio effect is played to convey that the HMD 304 is correctly positioned at a position corresponding to the predefined vantage point. Some implementations may also provide for audio effects at other points in time. For example, an audio chime may sound when the first digital target 306 first appears in the frame, signaling that the user 302 should begin to “look around” the scene for it, which is particularly useful in instances where the second digital target 308 initial ‘appears’ outside of the field-of-view of the HMD 304.

When the position of the HMD 304 is consistent with that of the predefined vantage point, the first digital target 306 and the second digital target 308 satisfy a predefined spatial relationship. The system may, at this point, automatically capture an image of the subject 312 or wait for the user 302 to provide an input that triggers capture of the image. For example, the audio or visual cue may inform the user 302 that the HMD 304 is correctly positioned and the user may, at that time, provide touch or voice input to capture the photo.

FIG. 3D illustrates exemplary menu options 314 of an image inspection tool that may be presented following the capture of the photo as described above with respect to FIG. 3A-3C. Here, the exemplary menu options 314 are presented as part of a mixed-reality graphical user interface. The menu options 314 include “compare,” “try again,” and “done.” If the user selects the “compare” option, the image inspection tool may, for example, pull a reference image from a database and project the reference image side-by-side against the newly-captured image to allow the user 302 to subjectively evaluate similarities and differences between the two images. For example, a reference image of a non-defective product may be presented to allow the user 302 to evaluate whether a product present in the newly-captured image is defective.

In another implementation, the image inspection tool evaluates, in real-time, a similarity between the captured photo and one or more stored reference photos. A result of this comparison may be presented automatically or upon user selection of a relevant menu option, such as that shown by the exemplary warning message 316 (e.g., “Possibly not correct”). The user 302 may accept the newly-captured photo by selecting “done” or re-start the image capture process again by selecting “try again.”

Some implementations may further provide for options that allow either the user 302 or a system administrator to zoom or crop the newly-captured photo, so as to ensure further consistency between images in an image set. In one implementation that provides digital options for zooming and cropping, the mixed reality frame alignment tool may impose more relaxed target alignment criteria, such as criteria that does not depend upon the depth of separation between the HMD 304 and the image subject 312.

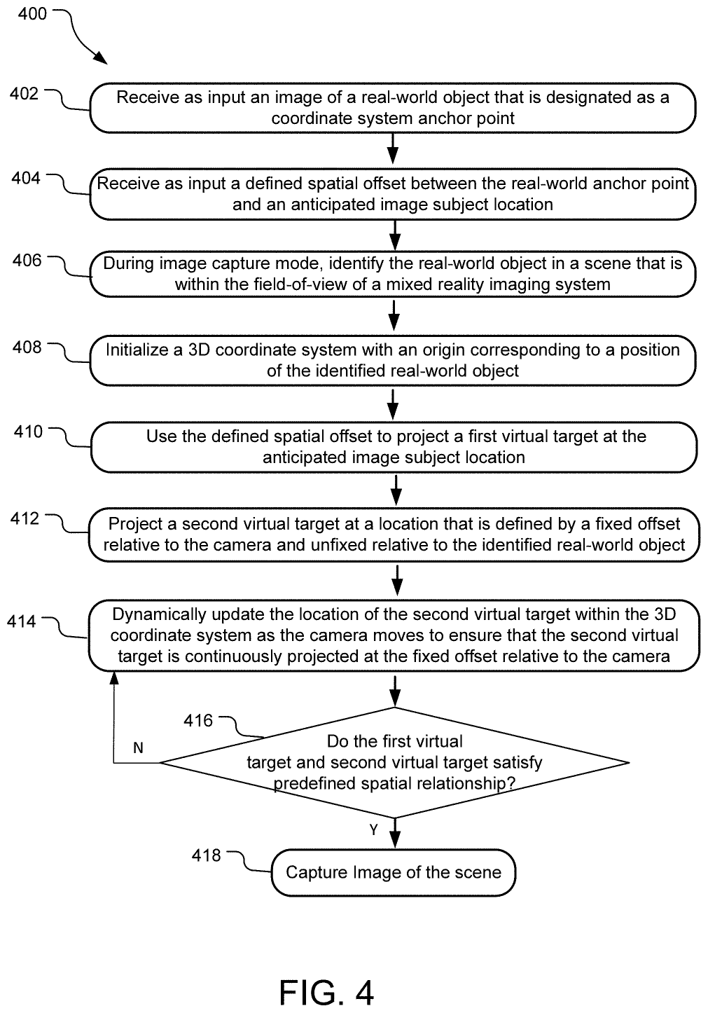

FIG. 4 illustrates example operations for guiding a user to position a camera at a predefined vantage point relative to an image subject. A first receiving operation 402 receives an input image of a real-world object designating a coordinate system anchor point. A second receiving operation 404 receives an input defining a spatial offset (e.g., a 2D or 3D vector) between the real-world anchor point and an anticipated image subject location. For example, a system administrator may provide the inputs of the receiving operations 402 and 404 to an application during an initialization or set-up process.

During an image capture mode of the application, an identification operation 406 identifies the real-world object within a scene that has been previously designated as the coordinate system anchor point. A coordinate system defining operation 408 defines a 3D coordinate system with an origin corresponding to a position of the identified real-world object, and a first projection operation 410 uses the defined spatial offset to project a first virtual target at the anticipated image subject location. A second projection operation 412 projects a second virtual target at a location that remains fixed in space relative to a system camera (e. defined by a fixed offset relative to the camera). As the user moves the camera, an update operation 414 dynamically updates the location of the second virtual target within the 3D coordinate system to ensure that the second virtual target is projected to continuously appear at the fixed offset relative to the camera, causing the first digital target to move in position so as to mirror movements of the camera. In one implementation, the update operation 414 alters a size of the first digital target based on the relative distance between the camera and the real-world anchor point.

A determining operation 416 determines whether the first virtual target and the second virtual target satisfy a predefined spatial relationship. In different implementations, the predefined spatial relationship may depend on one or more of relative position, orientation, and/or size of the two targets. If the determining operation 416 determines that the predefined spatial relationship is not satisfied, the update operation 414 is resumed until it is determined that the predefined spatial relationship is satisfied, at which time an image capture operation 418 captures an image of the image subject.

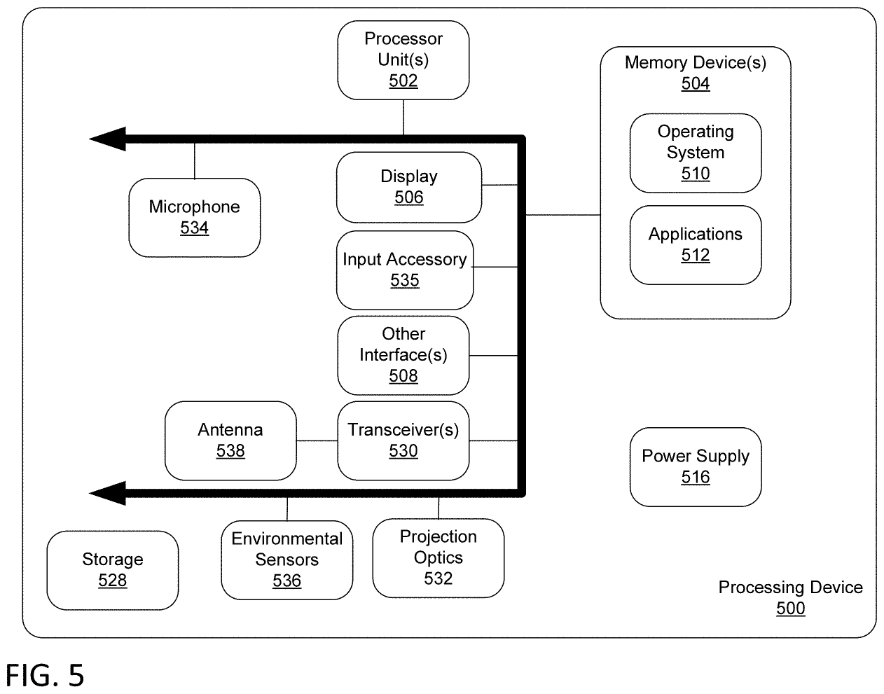

FIG. 5 illustrates an example schematic of a processing device 500 suitable for implementing aspects of the disclosed technology. The processing device 500 includes one or more processor unit(s) 502, memory 504, a display 506, and other interfaces 508 (e.g., buttons). The memory 504 generally includes both volatile memory (e.g., RAM) and nonvolatile memory (e.g., flash memory). An operating system 510, such as the Microsoft Windows® operating system, the Microsoft Windows® Phone operating system or a specific operating system designed for a mixed reality device, resides in the memory 504 and is executed by the processor unit(s) 502, although it should be understood that other operating systems may be employed.

One or more applications 512, such as the mixed reality frame alignment tool 114 and/or the image inspection tool 116 of FIG. 1 are loaded in the memory 504 and executed on the operating system 510 by the processor unit(s) 502. Applications 512 may receive input from various input devices such as a microphone 534, input accessory 535 (e.g., keypad, mouse, stylus, touchpad, gamepad, racing wheel, joystick), or inputs from various environmental sensors 536 such as one or more cameras, microphones, etc. The processing device 500 includes projection optics 532 for projecting virtual objects when operating in a virtual or mixed reality mode. The processing device 500 further includes a power supply 516, which is powered by one or more batteries or other power sources and which provides power to other components of the processing device 500. The power supply 516 may also be connected to an external power source (not shown) that overrides or recharges the built-in batteries or other power sources.

The processing device 500 includes one or more communication transceivers 530 and an antenna 538 to provide network connectivity (e.g., a mobile phone network, Wi-Fi®, Bluetooth®). The processing device 500 may also include various other components, such as a positioning system (e.g., a global positioning satellite transceiver), one or more accelerometers, one or more cameras, an audio interface (e.g., the microphone 534, an audio amplifier and speaker and/or audio jack), and storage devices 528. Other configurations may also be employed.

In an example implementation, a mobile operating system, various applications (e.g., a depth ray shader) and other modules and services may have hardware and/or software embodied by instructions stored in the memory 504 and/or the storage devices 528 and processed by the processor unit(s) 502. The memory 504 may be the memory of a host device or of an accessory that couples to the host.

The processing device 500 may include a variety of tangible computer-readable storage media and intangible computer-readable communication signals. Tangible computer-readable storage can be embodied by any available media that can be accessed by the processing device 500 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 600. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

An example device disclosed herein includes a mixed reality frame alignment tool stored in memory and executable by a processor to: identify a real-world anchor object within a field-of view of a camera; control projection optics to project a first virtual target at a first location within the field-of-view that is fixed relative to the identified real-world anchor object; control the projection optics to project a second virtual target at second location within the field-of-view, the second location being fixed relative to a position of the camera; and dynamically update a position of the projected second virtual target to mirror movements of the camera as the camera is moved relative to the real-world anchor object. The system further comprises an image capture tool stored in memory and executable to capture a photo of an image subject within the camera field-of-view when the first location and the second location satisfy a predefined spatial relationship.

In another example device of any preceding system, the mixed reality frame alignment tool determines the first location of the first digital target using an offset that is predefined with respect to a position of the real-world anchor object. The first location corresponds to a location of the image subject.

In still another device of any preceding device, the mixed reality frame alignment tool is further executable to: define a three-dimensional coordinate system with an origin corresponding to a location of the real-world anchor object, the first location of the first virtual target being fixed within the three-dimensional coordinate system relative to the identified real-world anchor object.

In yet another example device of any preceding device, the mixed reality frame alignment tool evaluates satisfaction of the predefined spatial relationship by determining whether an alignment between the camera and the image subject is consistent with an alignment between a predefined vantage point and the image subject.

In still yet another example device of any preceding device, the first virtual target remains fixed in size while the camera is moved in space and the second virtual target varies in size as the camera is moved in space. The size of the second virtual target varies based on a distance between the camera and the predefined vantage point.

In yet still another example device of any preceding device, an angular separation between the first virtual target and the second virtual target varies as the angular orientation of the camera is varied with respect to the predefined vantage point.

In still another example device of any preceding device, the first virtual target remains fixed in size while the camera is moved in space and the second virtual target varies in at least one of size and orientation as the camera is moved in space.

In yet still another example device of any preceding device, the mixed reality frame alignment tool is further executable to capture the photo automatically without user input responsive to satisfaction of the predefined spatial relationship.

An example tangible computer-readable storage media disclosed herein encodes computer-executable instructions for executing a computer process that includes: identifying a real-world anchor object within a camera field-of view; projecting a first virtual target at a first location within the camera field-of-view that is fixed relative to the identified real-world anchor object; projecting a second virtual target at second location within the camera field-of-view the second location being fixed relative to a position of the camera; dynamically updating a position of the projected second virtual target to mirror movements of the camera as the camera is moved relative to the real-world anchor object; and capturing a photo of an image subject within the camera field-of-view when the first location and the second location satisfy a predefined spatial relationship.

In another example computer-readable storage media of any preceding computer-readable storage media, the computer process further comprises: defining a three-dimensional coordinate system with an origin corresponding to a location of the real-world anchor object. The first location of the first virtual target is fixed within the three-dimensional coordinate system relative to the identified real-world anchor object.

In yet another example computer-readable storage media of any preceding computer-readable storage media, the first location of the first digital target is determined using an offset that is predefined with respect to a position of the real-world anchor object, and the first location correspondso a location of the image subject.

In still another example computer-readable storage media of any preceding computer-readable storage media, the encoded computer process further comprises: determining whether an alignment between the camera and the image subject is consistent with an alignment between the predefined vantage point and the image subject.

In another example computer-readable storage media of any preceding computer-readable storage media, first virtual target remains fixed in size while the camera is moved in space and the second virtual target varies in size as the camera is moved in space, the size of the second virtual target varying based on a distance between the camera and a predefined vantage point.

In still another example computer-readable storage media of any preceding computer-readable storage media, an angular separation between the first virtual target and the second virtual target varies as the angular orientation of the camera is varied with respect to the predefined vantage point.

In yet another example computer-readable storage media of any preceding computer-readable storage media, the encoded computer process further comprises providing the captured photo of the image subject to a machine learning model; receiving an output from the machine learning model, the output conveying an outcome of the evaluation; and presenting the output to the user on a graphical user interface. The machine learning model is trained on other images of the image subject to evaluate a condition of the subject.

In still another example computer-readable storage media of any preceding computer-readable storage media, capturing the photo further comprises: capturing the photo automatically without user input responsive to satisfaction of the predefined spatial relationship.

In another example computer-readable storage media of any preceding computer-readable storage media, capturing the photo further comprises: providing the user with at least one of audio or visual feedback responsive to the capture of the photo.

An example method disclosed herein comprises: identifying a real-world anchor object within a camera field-of view; projecting a first virtual target at a first location within the camera field-of-view that is fixed relative to the identified real-world anchor object; projecting a second virtual target at second location within the camera field-of-view the second location being fixed relative to a position of the camera; dynamically updating a position of the projected second virtual target to mirror movements of the camera as the camera is moved relative to the real-world anchor object; and capturing a photo of an image subject within the camera field-of-view responsive to determining that the first location and the second location satisfy a predefined spatial relationship.

In another example method of any preceding method, the first virtual target remains fixed in size while the camera is moved in space and the second virtual target varies in at least one of size and orientation as the camera is moved in space.

In yet another example method of any preceding method, the first location of the first location of the first digital target is determined based on an offset that is predefined with respect to the anchor object, the first location corresponding to a location of the image subject.

An example system disclosed herein comprises: a means for identifying a real-world anchor object within a camera field-of view; a means for projecting a first virtual target at a first location within the camera field-of-view that is fixed relative to the identified real-world anchor object; a means for projecting a second virtual target at second location within the camera field-of-view the second location being fixed relative to a position of the camera; a means for dynamically updating a position of the projected second virtual target to mirror movements of the camera as the camera is moved relative to the real-world anchor object; and a means for capturing a photo of an image subject within the camera field-of-view responsive to determining that the first location and the second location satisfy a predefined spatial relationship.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendix, provide a complete description of the structure and use of exemplary implementations.

What is claimed is:

1. A device comprising:
a mixed reality frame alignment tool stored in memory and executable by a processor to:
identify a real-world anchor object within a field-of view of a camera;
control projection optics to project a first virtual target at a first location within the field-of-view that is fixed relative to the identified real-world anchor object;
control the projection optics to project a second virtual target at second location within the field-of-view, the second location being fixed relative to a position of the camera;
dynamically update a position of the projected second virtual target to mirror movements of the camera as the camera is moved relative to the real-world anchor object; and
an image capture tool stored in memory and executable to capture a photo of an image subject within the camera field-of-view when the first location and the second location satisfy a predefined spatial relationship.

2. The device of claim 1, wherein the mixed reality frame alignment tool determines the first location of the first digital target using an offset that is predefined with respect to a position of the real-world anchor object, the first location corresponding to a location of the image subject.

3. The device of claim 1, wherein the mixed reality frame alignment tool is further executable to:
defining a three-dimensional coordinate system with an origin corresponding to a location of the real-world anchor object, the first location of the first virtual target being fixed within the three-dimensional coordinate system relative to the identified real-world anchor object.

4. The device of claim 1, wherein the mixed reality frame alignment tool evaluates satisfaction of the predefined spatial relationship by determining whether an alignment between the camera and the image subject is consistent with an alignment between a predefined vantage point and the image subject.

5. The device of claim 4, wherein the first virtual target remains fixed in size while the camera is moved in space and the second virtual target varies in size as the camera is moved in space, the size of the second virtual target varying based on a distance between the camera and the predefined vantage point.

6. The device of claim 4, wherein an angular separation between the first virtual target and the second virtual target varies as the angular orientation of the camera is varied with respect to the predefined vantage point.

7. The device of claim 1, wherein the first virtual target remains fixed in size while the camera is moved in space and the second virtual target varies in at least one of size and orientation as the camera is moved in space.

8. The device of claim 1, wherein the mixed reality frame alignment tool is further executable to:
capture the photo automatically without user input responsive to satisfaction of the predefined spatial relationship.

9. One or more tangible computer readable storage media encoding computer-executable instructions for executing a computer process, the computer process including:
identifying a real-world anchor object within a camera field-of view;
projecting a first virtual target at a first location within the camera field-of-view that is fixed relative to the identified real-world anchor object;
projecting a second virtual target at second location within the camera field-of-view the second location being fixed relative to a position of the camera;
dynamically updating a position of the projected second virtual target to mirror movements of the camera as the camera is moved relative to the real-world anchor object;
capturing a photo of an image subject within the camera field-of-view when the first location and the second location satisfy a predefined spatial relationship.

10. The tangible computer-readable storage media of claim 9, wherein the computer process further comprises:
defining a three-dimensional coordinate system with an origin corresponding to a location of the real-world anchor object, the first location of the first virtual target being fixed within the three-dimensional coordinate system relative to the identified real-world anchor object.

11. The tangible computer-readable storage media of claim 9, wherein the first location of the first digital target is determined using an offset that is predefined with respect to a position of the real-world anchor object, the first location corresponding to a location of the image subject.

12. The tangible computer-readable storage media of claim 9, wherein the computer process further comprises:
determining whether an alignment between the camera and the image subject is consistent with an alignment between the predefined vantage point and the image subject.

13. The tangible computer-readable storage media of claim 9, wherein the first virtual target remains fixed in size while the camera is moved in space and the second virtual target varies in size as the camera is moved in space, the size of the second virtual target varying based on a distance between the camera and a predefined vantage point.

14. The tangible computer-readable storage media of claim 13, wherein an angular separation between the first virtual target and the second virtual target varies as the angular orientation of the camera is varied with respect to the predefined vantage point.

15. The tangible computer-readable storage media of claim 13, wherein the computer processes further comprises:
providing the captured photo of the image subject to a machine learning model, the machine learning model being trained on other images of the image subject to evaluate a condition of the subject;
receiving an output from the machine learning model, the output conveying an outcome of the evaluation; and
presenting the output to the user on a graphical user interface.

16. The tangible computer-readable storage media of claim 9, wherein capturing the photo further comprises:
capturing the photo automatically without user input responsive to satisfaction of the predefined spatial relationship.

17. The tangible computer-readable storage media of claim 9, wherein the method further comprises:
providing the user with at least one of audio or visual feedback responsive to the capture of the photo.

18. A method comprising:
identifying a real-world anchor object within a camera field-of view;
projecting a first virtual target at a first location within the camera field-of-view that is fixed relative to the identified real-world anchor object;
projecting a second virtual target at second location within the camera field-of-view the second location being fixed relative to a position of the camera;
dynamically updating a position of the projected second virtual target to mirror movements of the camera as the camera is moved relative to the real-world anchor object;
responsive to determining that the first location and the second location satisfy a predefined spatial relationship, capturing a photo of an image subject within the camera field-of-view.

19. The method of claim 18, wherein the first virtual target remains fixed in size while the camera is moved in space and the second virtual target varies in at least one of size and orientation as the camera is moved in space.

20. The method of claim 18, wherein the first location of the first location of the first digital target is determined based on an offset that is predefined with respect to the anchor object, the first location corresponding to a location of the image subject.
